(19) United States
(12) Patent Application Publication
(10) Pub. No.: US 2002/0010725 A1
(43) Pub. Date: Jan. 24, 2002

(54) Internet-based font server

(76) Inventor: Lawrence Wai Ming Mo, Mid Level (HK)

Correspondence Address: LEYDIG VOIT & MAYER, LTD, 700 THIRTEENTH ST. NW, SUITE 300, WASHINGTON, DC, 20005-3960, US

(21) Appl. No.: 09/863,250

(22) Filed: May 24, 2001

Related U.S. Application Data
(63) Continuation-in-part of application No. 09/537,042, filed on Mar. 28, 2000.

(51) Int. Cl. G06F 17/21

(52) U.S. Cl. 707/530

(57) ABSTRACT

An Internet-based font server (10) for access by an Internet browser (20) to provide the browser (20) with representations of text elements, such as ideographic characters, in one of a plurality of languages for browsing a web page (30) in that language over the Internet. The server (10) comprises an associated website for access by the browser (20), a database of ideographic character fonts of different sizes and styles, first means (31) for downloading the web page (30) to the server (10), and a parser program (40). The parser program (40) is arranged to identify text codes of the ideographic characters in the web page (30) and replace the identified text codes with respective URL (Uniform Resource Locator) addresses, thereby converting the text of the web page (30) into said URL addresses. The server (10) includes second means (46) for returning the converted web page to the browser (20), and third means (43) for downloading the font files via the respective URL addresses to the browser (20) upon request by the browser (20). Alternatively, the parser program (40) may be located at the browser (20).

This patent application is a continuation-in-part of U.S. patent application Ser. No. 09/537,042 filed Mar. 28, 2000.

The present invention relates to an Internet-based font server for browsing web pages in global languages, particularly but not exclusively languages of ideographic nature, such as Chinese, Japanese and Korean characters (collectively known as CJK characters).

### BACKGROUND OF THE INVENTION

In general, in order to be able to display texts in a particular language such as CJK characters, the operating system of a computer usually incorporates a font rendering system, such as TrueType in Microsoft Windows, which utilises font files resident in the local hard disk. The font files must be compatible with the particular font rendering system, which generates a bitmap of a character from the font files for use by the operating system and application software. One such application is using an Internet browser to access web information. The browser makes use of the font rendering system in the operating system to generate a bitmap of the text information for display on screen. Although the font rendering system supports different sizes and styles of the characters as specified by the web pages, different font files are required for the font rendering system to work in different languages.

The advent of the Internet and related technologies has prompted the growth of a new generation of devices generally known as web or information appliances using the Internet for the communication of multimedia information, which are typically equipped with only limited computing power and small memory just sufficient to run a micro version of a standard Internet browser. Examples of such devices are Wireless Application Protocol or WAP based mobile phones, set-top boxes and screen phones. Due to their limited capacity, only a rather basic font rendering system can be implemented to support one style of fonts of one or two sizes at most, particularly for the viewing and input of CJK characters.

The invention seeks to mitigate or at least alleviate such problems by providing an Internet-based font server.

### SUMMARY OF THE INVENTION

According to a first aspect of the invention, there is provided an Internet-based font server for access by an Internet browser to provide a said browser with representations of text elements in one of a plurality of languages for browsing a web page in that language over the Internet, which server comprises an associated website for access by said browser, a database of text element fonts of different sizes and styles, first means for downloading a said web page to the server, a parser program for identifying text codes of the text elements in said web page and replacing the identified text codes with respective URL (Uniform Resource Locator) addresses, thereby converting the text of a said web page into said URL addresses, and second means for returning the converted web page to a said browser.

Preferably, the parser program is arranged to generate respective font files for the identified text codes and create said URL addresses for the respective font files to replace the identified text codes with the URL addresses.

More Preferably, said second means is arranged to return the converted web page to a said browser by downloading successively the font files via the respective URL addresses.

It is preferred that the server is arranged to pack the font files into a single data packet for said second means to return the converted web page to a said browser.

It is preferred that the server is arranged to match the font characteristics as specified in a said web page to produce a closest match of the intended font appearance for said second means to return the converted web page to a said browser.

In a preferred embodiment, the text elements are ideographic characters.

More preferably, the server includes a database associated with a standard ideographic character input method and is arranged to match a received keystroke pattern of a character according to the input method with the corresponding pattern in the input method database to identify the character and then create a unique URL address for that character, by means of the parser program, for subsequent download to a said browser.

It is preferred that the URL addresses are determined according to an encoding scheme, in which each URL address comprises the address of the website, the text code for the respective text element and a national code for the relevant font.

According to a second aspect of invention. There is provided an Internet-based front server for access by an Internet browser to provide said browser with representations of text elements in one of a plurality of languages for browsing a web page in that language over the Internet, which server comprises an associated website for access by said browser, a database of text element fronts of different sizes and styles, first means arranged to download said web page to the server, a parser program arranged to identify text codes of the text elements in said web page, generate respective font files for the identified text codes, and replace the identified text codes with URL (Uniform Resource Locator) addresses for the respective font files, thereby converting the text of said web page into said URL addresses, second means arranged to return the converted web page to said browser, and third means arranged to download the font files via the respective URL addresses to said browser upon request by said browser.

According to a third aspect of the invention, there is provided an Internet-based font server for access by an Internet browser to provide said browser with representations of text elements in one of a plurality of languages for browsing a web page in that language over the Internet, which server comprises an associated website for access by said browser, a database of text element fonts of different sizes and styles, a parser program at said browser for identifying text codes of the text elements in said web page and replacing the identified text codes with respective URL (Uniform Resource Locator) addresses, thereby converting the text of said web page into said URL addresses, first means for generating corresponding font files at the respective URL addresses for the identified text codes, and second means for downloading the font files via the respective URL addresses to said browser upon request by said browser.

Preferably, the server is arranged to pack the font files into a single data packet for download by the second means.

It is preferred that the text elements are ideographic characters.

It is preferred that the URL addresses are determined according to an encoding scheme, in which each URL address comprises the address of the website, the text code for the respective text element and a national code for the relevant font.

### BRIEF DESCRIPTION OF DRAWINGS

The invention will now be more particularly described, by way of example only, with reference to the accompanying drawings, in which:

FIG. 1 is a flow chart illustrating the operation of a first embodiment of an Internet-based font server in accordance with the invention, incorporating a parser program, in response to an Internet browser in a system that does not incorporate a local cache manager;

FIG. 2 is a flow chart illustrating the operation of the font server of FIG. 1, in response to an Internet browser in a system that incorporates a local cache manager; and

FIG. 3 is a flow chart illustrating the operation of a second embodiment of an Internet-based font server in accordance with the invention, in response to an Internet browser that incorporate a local parser program.

### DETAILED DESCRIPTION OF PREFERRED EMBODIMENT

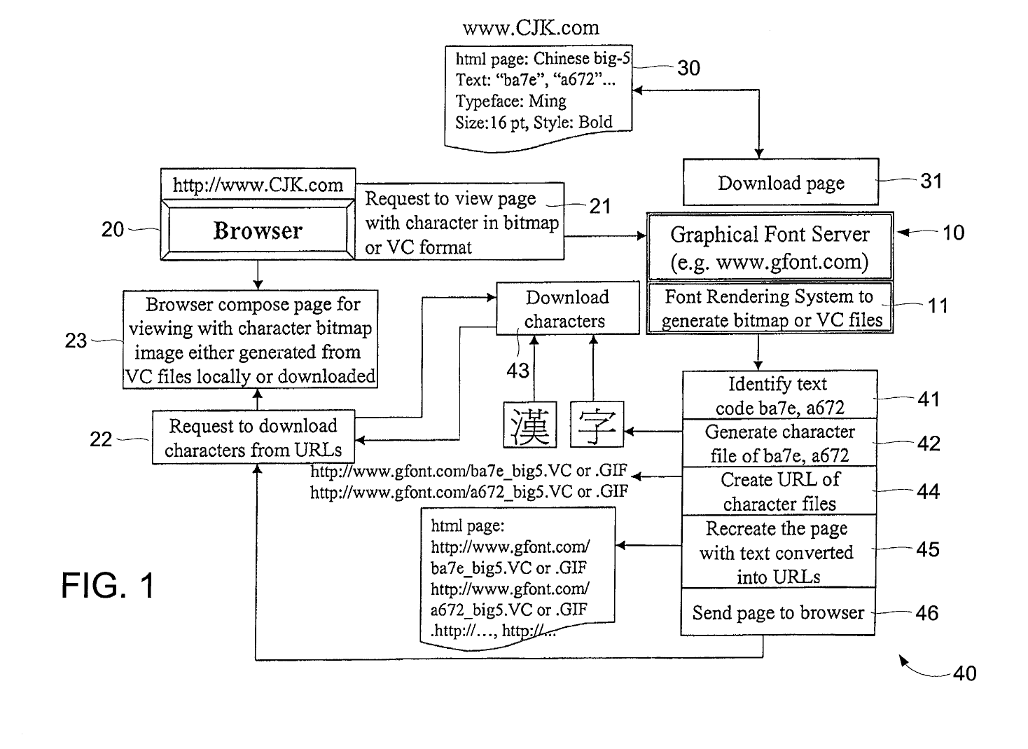

Referring initially to FIG. 1 of the drawings, there is shown a first Internet-based font server 10 embodying the invention, which server 10 incorporates a database of character fonts of different languages, such as Chinese, Japanese and Korean or CJK character fonts, and different sizes and styles, and a font rendering system 11. The server 10 has an associated website, which may be called www.gfont.com, for access as an interface upon request by any standard Internet browser 20 in a TCP/IP based network to provide the browser 20 with graphical representations of CJK characters for browsing a specific web page 30 coded in HTML, WML and/or XML formats. The web page 30 may be called www.CJK.com and may include a big5 Chinese text beginning with character or text codes “ba7e”, “a672” . . . , of typeface Ming, size 16 pt and style bold.

The font server 10 responds to a request issued by the browser 20 for viewing and input of CJK characters in bitmap or vector graphic format (step 21) over the web page 30. In operation, the web page 30 is first downloaded to the font server 10 (step 31). A parser program 40 of the font rendering system 11 will then be invoked to identify the text codes “ba7e”, “a672” . . . of all the CJK characters in the web page 30 (step 41) generating respective character font graphic files for the identified text codes (step 42) in the server 10 ready for download (step 43), and replace the text codes with respective URL (Uniform Resource Locator) addresses corresponding to the graphical representations of the CJK characters in GIF format or other browser compatible images or vector graphic formats, by creating the URL addresses for the respective graphic files (step 44). The web page 30 is thus converted with its text into the aforesaid URL addresses (step 45), and the converted web page will subsequently be returned to the browser 20 (step 46).

The text code of each CJK character is uniquely preserved in the corresponding URL address which identifies the national coding scheme or Unicode font. The font rendering system 11 serves to produce a bitmap or vector graphic representation of the required size and style of each character font and convert the bitmap into GIF, BMP or any other browser-supported raster graphic format or convert the vector graphic representation into a browser compatible vector graphic format for generating a corresponding graphic file with a unique URL address.

The browser 20 responds by requesting to download successively the graphic files of the corresponding CJK characters from the server 10 via the respective URL addresses (step 22) for page composition with character bitmap images either generated from vector graphic files locally or downloaded (step 23) and subsequent display and viewing on the screen. The font server 10 will try to match the font characteristics, such as size and style, as specified in the web page 30 and produce a closest match of the intended character appearance in graphic format for downloading.

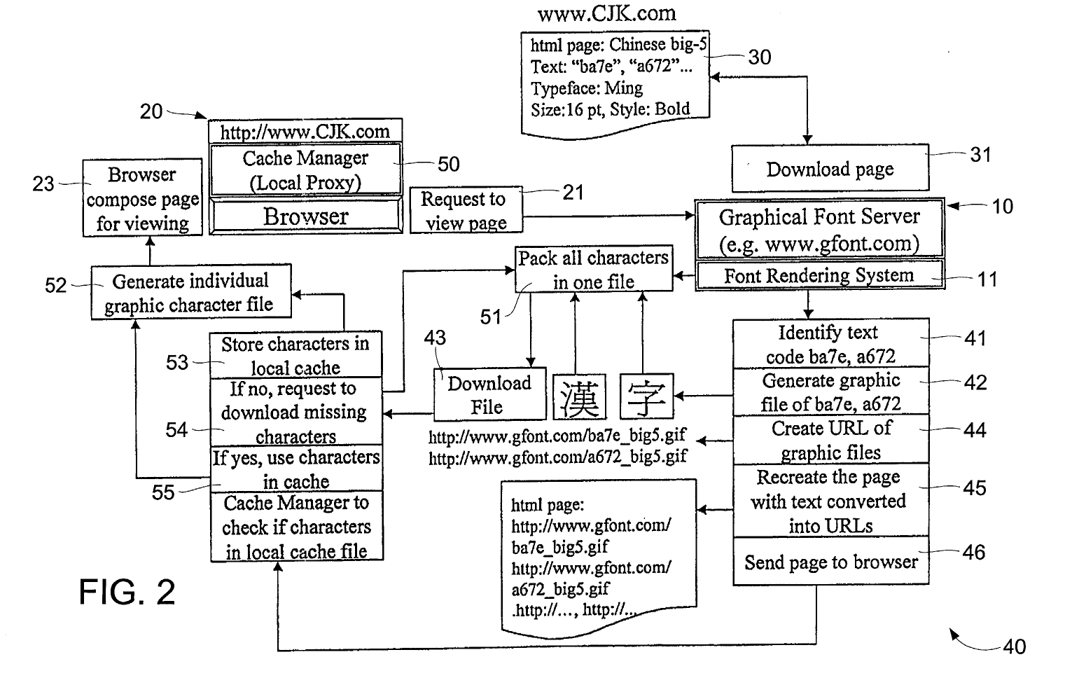

Reference is now made to FIG. 2 of the drawings, which illustrates the use of the font server 10 by the browser 20 in a system which incorporates a local proxy server or cache manager 50. The operation of the server 10 and the browser 20 follows closely as that described above in relation to FIG. 1, with equivalent components and steps designated by the same reference numerals. In order to shorten the download time on the Internet, the server 10 packs the requested character graphic files into a single data file or packet (step 51) for subsequent downloading to the browser 20 (step 43). Based on proxy server technology as specified in Hyper Text Transfer Protocol (HTTP), the browser 20 requests to download, as a single packet or in a single transmission, all the graphic characters from the server 10 for each web page viewing session. This will minimise the handshaking steps as required by the use of the URL addresses for successively downloading each character.

The data packet will be processed by the local cache manager 50 for the following two purposes: first to extract each individual graphic character and generate a unique local URL address for an individual character graphic file (step 52), and second to store the characters in the local cache (step 53) such that no future downloading of the same character will be required. More specifically, if a particular character is not found in the local cache, a request is issued to download the missing character from the font server 10 (step 54). On the other hand, if that character is found in the local cache, it will be retrieved from the local cache for use (step 55), without being downloaded again from the server 10. Accordingly, a local character font cache system may be built.

The font server 10 supports most standard CJK character input methods by including databases associated with such input methods. In operation, the browser 20 sends a series of keystrokes of a character according to the input method to the server 10, which in turn matches the keystroke pattern with the corresponding pattern in the input method database to identify the corresponding character. The server 10 will then create a unique URL address for that character, by means of the parser program (40) as described above, for subsequent download to the browser 20 and display on the screen.

It is envisaged that the subject font server may be set up to work on both character-based texts and/or letter-based texts, which are formed by characters and/or letters (making up words) as text elements. Examples of letter-based texts are English, French, Hebrew and Hindi, for which the letters are to be downloaded via the corresponding URL addresses.

In the drawings, there are shown two examples of an URL address, which are “http://www.gfont.com/ba7e_big5.VC or .GIF” and “http://www.gfont.com/a672_big5.VC or .GIF” for big5 Chinese characters having respective text codes “ba7e” and “a672”. The URL addresses are determined according to an encoding scheme, in which each URL address is made up by three major components, namely (1) the server website address “www.gfont.com”, (2) the text code “ba7e” or “a672” for the relevant character and (3) the national code for the relevant character font. For letter-based texts, taking English as an example, the ASCII code of each letter is used as its text code. The encoded URL addresses are readily readable by any existing computing devices.

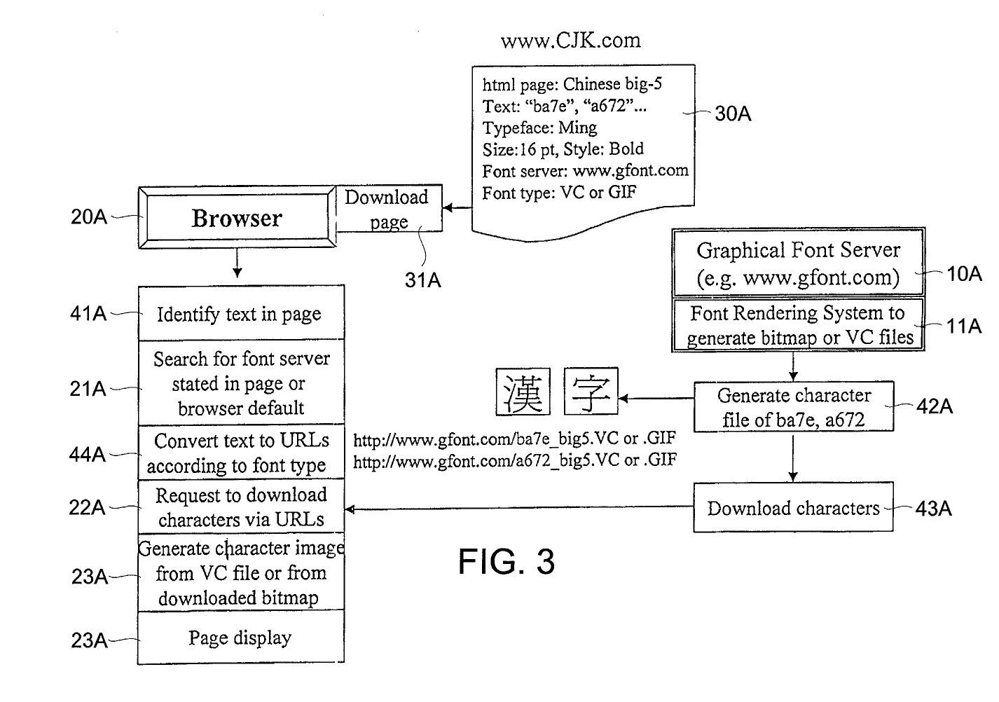

Referring now to FIG. 3 of the drawings, there is shown a second Internet-based font server 10A embodying the invention, in which the overall system as shown comprises essentially the same components (functional steps) as in the overall system of FIG. 1, with equivalent components designated by the same corresponding reference numerals suffixed by a letter “A”. Some of the components are modified, or their order in performance changed, where appropriate, as will be apparent from the following description. The major difference lies in the location of the parser program 40A, in that its principal functions have now been integrated into or with the Internet browser 20A for co-operation with the font server 10A as remote components thereof.

The principal functions of the parser program 40A, which have been transferred to the Internet browser 20A are:

Step 41A—Identifying the text codes “ba7e”, “a672” . . . of all the CJK characters in the web page 30A

Step 44A—Replacing the text codes with, or converting them into respective URL (Uniform Resource Locator) addresses corresponding to the graphical representations of the CJK characters in GIF format or other browser compatible images or vector graphic formats, by creating the URL addresses for the respective graphic files

In operation, the Internet browser 20A browses and downloads the web page 30A in CJK characters (step 31A) and then invokes the parser program 40A to perform steps 41A and 44A. The web page 30A may specify a particular font server for use, otherwise the default font server 10A will be used, to which the browser 20A will issue a request (step 21A) for downloading the necessary character font graphic files in bitmap or vector graphic format via the corresponding URL addresses (step 22A).

The font server 10A responds to the request by generating the required graphic files according to the identified text codes (step 42A) and then downloading such graphic files to the browser 20A (step 43A).

It is important to note that there is no need for the font server 10A to convert the web page 30A with its text into the aforesaid URL addresses (step 45 of FIG. 1), for subsequent return to the browser 20A (step 46 of FIG. 1). Such a converted web page will be much larger in size than the original web page 30A, and therefore inconvenient and/or slow to transmit over the Internet. As described above, the conversion of text codes into URL addresses is performed by the browser 20A into which the parser program 40A is integrated.

Upon receipt of the graphic files in bitmap or vector graphic format via the corresponding URL addresses (step 22A), the browser 20A will compose the web page 30A with character bitmap images either generated from vector graphic files locally or downloaded, for display and viewing on the screen (step 23A).

The subject invention provides an Internet-based font server, based on known Internet technologies, for downloading characters and/or letters or collectively text elements to browsers on demand, thereby avoiding the need for the browser systems to have the text element fonts resident in local devices. The use of the font server effectively creates a global font platform for the Internet and offers an unlimited font and language support to browsers of diverse Internet connected devices, such as personal computers, mobile phones, set-top boxes and screen phones, etc.

The invention has been given by way of example only, and various other modifications of and/or alterations to the described embodiments may be made by persons skilled in the art without departing from the scope of the invention as specified in the appended claims.

What is claimed is:

1. An Internet-based font server for access by an Internet browser to provide a said browser with representations of text elements in one of a plurality of languages for browsing a web page in that language over the Internet, which server comprises an associated website for access by a said browser, a database of text element fonts of different sizes and styles, first means for downloading said web page to the server, a parser program for identifying text codes of the text elements in said web page and replacing the identified text codes with respective URL (Uniform Resource Locator) addresses, thereby converting the text of said web page into said URL addresses, and second means for returning the converted web page to a said browser.

2. The Internet-based font server as claimed in claim 1, wherein the parser program is arranged to generate respective font files for the identified text codes and create said URL addresses for the respective font files to replace the identified text codes with the URL addresses.

3. The Internet-based font server as claimed in claim 2, wherein said second means is arranged to return the converted web page to a said browser by downloading successively the font files via the respective URL addresses.

4. The Internet-based font server as claimed in claim 2, wherein the server is arranged to pack the font files into a single data packet for said second means to return the converted web page to said browser.

5. The Internet-based font server as claimed in claim 1, wherein the server is arranged to match the font characteristics as specified in said web page to produce a closest match of the intended font appearance for said second means to return the converted web page to said browser.

6. The Internet-based font server as claimed in claim 1, wherein the text elements are ideographic characters.

7. The Internet-based font server as claimed in claim 6, wherein the server includes a database associated with a standard ideographic character input method and is arranged to match a received keystroke pattern of a character according to the input method with the corresponding pattern in the input method database to identify the character and then create a unique URL address for that character, by means of the parser program, for subsequent download to a said browser.

8. The Internet-based font server as claimed in claim 1, wherein the URL addresses are determined according to an encoding scheme, in which each URL address comprises the address of the website, the text code for the respective text element and a national code for the relevant font.

9. An Internet-based font server for access by an Internet browser to provide said browser with representations of text elements in one of a plurality of languages for browsing a web page in that language over the Internet, which server comprises an associated website for access by said browser, a database of text element fonts of different sizes and styles, first means arranged to download said web page to the server, a parser program arranged to identify text codes of the text elements in said web page, generate respective font files for the identified text codes, and replace the identified text codes with URL (Uniform Resource Locator) addresses for the respective font files, thereby converting the text of said web page into said URL addresses, second means arranged to return the converted web page to said browser, and third means arranged to download the font files via the respective URL addresses to said browser upon request by said browser.

10. An Internet-based font server for access by an Internet browser to provide said browser with representations of text elements in one of a plurality of languages for browsing a web page in that language over the Internet, which server comprises an associated website for access by said browser, a database of text element fonts of different sizes and styles, a parser program at said browser for identifying text codes of the text elements in said web page and replacing the identified text codes with representative URL (Uniform Resource Locator) addresses, thereby converting the text of said web page into said URL addresses, first means for generating corresponding font files at the respective URL addresses for the identified text codes, and second means for downloading the font files via the respective URL addresses to said browser upon request by said browser.

11. The Internet-based font server as claimed in claim 10, wherein the server is arranged to pack the font files into a single data packet for download by the second means.

12. The Internet-based font server as claimed in claim 10, wherein the text elements are ideographic characters.

13. The Internet-based font server as claimed in claim 10, wherein the URL addresses are determined according to an encoding scheme, in which each URL address comprises the address of the website, the text code for the respective text element and a national code for the relevant font.
